(19) United States
(12) Patent Application Publication
(10) Pub. No.: US 2005/0134982 A1
(43) Pub. Date: Jun. 23, 2005

(54) Blind spot curved mirror

(76) Inventor: Bob Stonecypher, Columbus, OH (US)

Correspondence Address: Steven A. Hill, 6487 Silverleaf Avenue, Reynoldsburg, OH, 43068, US

(21) Appl. No.: 10/745,081

(22) Filed: Dec. 23, 2003

(51) Int. Cl. G02B 7/182

(52) U.S. Cl. 359/872; 359/843

(57) ABSTRACT

Apparatus for reflecting to an observer images of objects in a rearward, adjacent blind sport area. The apparatus comprises a mirror so designed as to provide a true reflection of horizontal width size of the objects, a true reflection of horizontal position of the objects, and a wide angle vertical reflection of the objects. The apparatus provides additional safety by covering the blind sport area, and requiring minimal head turning. The apparatus has use in vehicles upon the roadways and waterways.

### CROSS-REFERENCE TO RELATED APPLICATIONS

Not Applicable

### FEDERALLY SPONSORED RESEARCH

Not Applicable

### SEQUENCE LISTING OF INVENTION

Not Applicable

1. Field of the Invention

The invention relates to the general arts of vehicles, safety, and in particular to rear view mirrors for motor and non-motor vehicles.

2. Background of the Invention

When a driver changes direction or driving lanes, or enters upon a freeway or other traffic lanes, a potential collision exists. The driver cannot easily see the area to the rear and sides of a motor vehicle, between the rear view mirror field of view and the driver's peripheral vision. The driver may turn his or her head to see the state of traffic in the lane about to be entered, or rely on one or more mirrors to show the traffic. This area is known as the blind spot. It is well known in the industry. Thousands of accidents happen as the result of the blind spot problem.

For convenience of discussion, we define some reference points about an automobile. Our reference points include the front, rear, passenger, and driver sides of the vehicle, as those terms are commonly used. Further included is the position of the driver as seated in the driving position

The Blind Spot Area

Consider the complete view surrounding a vehicle as a panoramic sweep of 360 degrees about the driver, including front, driver side, rear, and passenger side fields of view. Each such field of view comprises roughly one-fourth of the 360 degree span, or roughly 90 degrees. A rearward complete field of view comprises a field of view angle of 180 degrees, beginning on the driver side and sweeping around the rear to the passenger side. The rearward complete view includes the rear half of the driver and passenger side fields of view (45 degrees each, for a total of 90 degrees), and all of the rear field of view (roughly 90 degrees). The rearward complete field of view includes the visible and blind spot areas for the particular driver.

The presence of trucking industry vehicles on the roadways present an additional blind spot: the area low to the ground, and close to the truck trailer. Suppose a commercial semi tractor-trailer has a high tire radius, which creates an area under the trailer portion that is several feet above the roadway. If the driver were to rely solely on mirrors, the mirrors may reveal only the space under the trailer, and not the body. Thus, a driver may believe that the area is unoccupied, and may attempt to drive into that area.

Dealing with the Blind Spot

A driver has at least three ways of coping with the blind spot problem. The driver may use mirrors to reveal an object in the blind spots, may use head movements to look directly into the blind spots on both sides of the vehicle, or may ignore the matter and take a chance that no collision will happen.

Mirrors

Blind spot areas may be considered as the result of gaps in coverage of the rearward complete field of view. Traditionally, the rearward complete field of view is covered by driver peripheral vision, and fields of view presented by and among one or more mirrors that are aimed to the rear. In conventional passenger vehicles, three mirrors that are used: a driver side, interior middle, and a passenger side mirror. Other vehicles have only driver side and passenger mirrors. The precise dimensions of the blind spot vary, depending on the size and position of driver side, interior, and passenger side mirrors; as well as upon the position of the driver, and the particular driver's personal, physical attributes, such as height, and inter pupil distance.

As the three mirrors are traditionally arranged in a conventional passenger vehicle, their combined field of view, as derived from superposition of their individual fields of view, is approximately 52 degrees, more or less, of the 180 degree rearward complete field of view. This includes the rear field of view, and adjacent portions of the rear halves of the driver and passenger side fields of view.

Current mirror standards call for the driver side and interior mirrors to be planar, thus giving true reflections of images. The passenger side mirror is typically spherically convex, giving a wider-angle view. The passenger side mirror thus distorts the reflected image so that, as warnings on such mirrors state, “objects in mirror are closer than they appear.” Thus, the traditional visible field of view is approximately 22 degrees for the driver side and interior mirrors. It is approximately 30 degrees for the wide-view passenger side mirror. If optimally aligned, one would expect approximately 74 degrees of coverage into the rearward complete field of view, and would rely on peripheral vision and head-turning to complete the coverage. However, these traditional mirror fields of view often overlap. One result is the smaller, roughly 52 degree field of view. Also, gaps in alignment of the mirrors, with no overlap, leave potentially 106 degrees not covered.

Use of other mirror configurations, such as an aspherical mirror, further enlarge the rearward field of view of that mirror.

In A Simple Way to Prevent Blind Zone Accidents, George Platzer recommends a procedure for aligning the three mirrors to reduce the blind spot area. According to Platzer, drivers improperly align the fields of view of the driver side and passenger side mirrors to reflect a portion of the side of the vehicle. A result is an overlapping with the field of view of the interior mirror. This, in turn, causes a significant blind spot. Platzer recommends that the driver side and passenger side mirrors be shifted outward and away from the vehicle. The overlap with the field of view of the interior mirror would be reduced. Fields of view of the driver side and passenger side mirrors are aimed more directly into the traditional blind spot area. Although Platzer's method has achieved some success, some reduced blind spot areas remain, into which sufficiently small vehicles may hide. Further, The National Safety Council, as reported in Side Mirror Adjustment, http://www.nasoceana.navy.mil/Safety/Home%20Page/SideMirrorAdjustment.htm (last visited Oct. 29, 2003) indicates that Platzer's method is not effective for vehicles with only two mirrors, namely the driver side and passenger side mirrors. This class of vehicles includes commercial trucks, vans, buses, and pick-up trucks that are hauling other view obstructing entities, and sport utility vehicles (“SUV”).

Other inventions reveal images on the blind spot area. However, a problem exists with many of them. Suppose a commercial semi tractor-trailer has a high tire radius, which creates an area under the trailer portion that is several feet above the roadway. Current blind sport mirror designs include a class that reveals the area under the trailer but not the body of the trailer of the wheels. Thus, a driver may believe that the area is unoccupied, and may attempt to drive into that area.

For example, so called “spot mirrors,” which are typically sections of a spherical convex mirror, can be added to existing mirrors, and thus give a wider-angle view. A problem exists with this for some drivers, in that the images are distorted as to their true size and position. The farther away an object is in the spot mirror, the smaller it is. Combining a small image with a significantly greater speed, the image may be unnoticed by the driver.

Furthermore, original equipment mirrors do not conveniently reveal the area under a trailer of a semi tractor-trailer vehicle, unless they are repositioned to point to that area. If repositioned to reveal that area, then other blind spots are not covered. Spherical convex, or “spot” mirrors are currently used for this purpose. Their use, however, suffers again from distortion and misrepresentation of the distance. Further distorted is the true position of objects in this additional blind spot.

Head Turning

Drivers of different ages tend to have different approaches to handling the blind spot problem, according to the U.S. Department of Transportation, Highway Safety Division. In a study entitled Non-planar driver's side rearview mirrors, DOT HS 809 149, September 2000, the Department of Transportation studied European driver behavior and mirror types (planar, spherical convex, and aspherical), with respect to age and experience. Among the conclusions were these:
Older drivers look over their shoulders, into the blind spot, less often than do younger drivers.
Driver head turning decreases with increasing mirror convexity.
Younger drivers feel safer and confident, than do older drivers, in using non-planar mirrors as the primary means of seeing into the blind spot before changing lanes.
Older drivers prefer the truer images of planar mirrors, to indicate distance and position of objects in the blind spot area.
   Blind Spot Problem on Waterways

The blind spot problem exists on waterways, as well, as they are becoming increasingly crowded. A boat driver must be aware of other objects in the blind spot the same as road drivers. As is the case for vehicles that travel upon streets and highways, waterway vehicle accidents are common. When pulling water skiers, the boat driver must know where the skiers are at all times. The skier may be anywhere in the complete rearward view, depending upon actions of the skier and other variables.

Although the configuration of mirrors, driver position, and driver characteristics may result in a blind spot pattern that is different than that of an automobile, skiers are often in the blind spot area. Further, drivers must remain aware of any forward hazards for the boat or skier. This leads to similar choices for the boat driver as exists for the automobile driver: use optimally aimed mirrors, use spherical or aspherical convex mirrors, turn one's head to look away from forward direction of travel and into the blind spot, or do not look at the skiers.

Prior Art is Inadequate

Before entering into the blind spot area on a roadway, the driver has at least three choices. He or she may rely on the existing driver side, interior, and passenger side rear view mirrors that have limited area viewing and leave a large blind spot. He or she may use a spherical convex blind spot curved mirror on the passenger or driver side, which does not give a true position of an image in the mirror. He or she may turn to look away from forward traffic, and momentarily into the blind spot area; hoping that no risk arises in front of the vehicle during the time that he or she is looking away. Unfortunately, some drivers do not look by any means, assume there are no other vehicles in the blind spot area, and move the vehicle into that lane.

The prior art alleviates the problem somewhat, but rely on the driver to properly position the available mirrors, and to properly interpret the position and size of objects that are revealed by way of the mirrors.

Suppose we use larger mirrors, for larger fields of view. A flat mirror that is large enough to show both the blind spot area and the rear view is likely also large enough to restrict a driver's real-time side and forward views; thus presenting an additional, different hazard. A larger spherical convex mirror has a larger field of view, but also distorts visual information and cues about the true position of objects in the field of view.

Suppose we rely less on mirrors, and more on direct glances. A driver may turn his or her eyes away from forward vision to look directly into the blind spot, hoping that no hazard arises in front while the glance is elsewhere. A risk exists with that approach, the longer the driver's eyes are not facing forward.

The worst approach, of course, is for the driver to assume that there is nothing in the blind spot area, not look into mirrors or look directly, and then change lines. This relies further on hope that other drivers, in the blind spot, will have good forward vision, and are not themselves looking away into their own blind spot areas in anticipation of changing lanes.

Vehicle rear view mirrors either do not view large enough areas or too large an area. The flat left side original vehicle mirror does not image the blind spot. The convex right side mirror and other convex or concave mirror images are confusing as to the location and distance of the object and what is shown because of the enlarged area and small images.

Current rear view mirrors for water vehicle mirrors have the same problems as do current rear view mirrors of land vehicles, in not presenting an adequate image the blind spot for their drivers. However, a lone driver who is towing skiers must be vigilant in both watching the skier and watching the path ahead.

Whether on land or water, a driver who turns away to look into a blind spot area risks collision with objects that may already be in the driver's path.

Need

Accordingly, a need exists in the art for apparatus to display images of objects in the blind spot, in such a way as to not mislead the driver as to the true horizontal width size of the objects in the blind spot, and so as the true horizontal position of objects in the blind spot area. Particularly for older drivers, and any driver who distrusts the false representations of horizontal width size and horizontal position, the driver's need to turn away to look into the blind spot is reduced significantly.

### SUMMARY OF THE INVENTION

It is an object of the invention to provide a mirror that shows images in the blind spot area, so that the images represent the true width horizontal image size and to present the true horizontal position of another vehicle in the blind spot area.

It is also an object of the invention to prevent undue head movement of drivers of motor and non-motor vehicles from their forward division, by improving their vision of the blind spot area.

It is a further object of this invention to provide a wider field of view of the blind spot area in the vertical.

The invention, a blind spot curved mirror, comprises a mirror formed from a reflective surface that is curved in one dimension (a single curved surface), with the curve being in a profile plane. The curved, reflective surface is generally the outside surface and section of a cylinder. The blind spot curved mirror is deposed generally horizontally, and is convex outwardly in a profile plane, and towards an observer or towards an area to be observed. The blind spot curved mirror is attached to a vehicle, on the driver side, the passenger side, or both. It is aimed by the driver, as observer, into the corresponding driver side or passenger side blind spot area.

Having a singly curved reflective surface and being oriented horizontally, the blind spot curved mirror has several novel and useful properties with respect to resolving the blind spot problem. Among these properties are:
True representation of horizontal width of objects in the blind spot area, giving undistorted representation of width size as would a flat, planar mirror;
True representation of horizontal position of objects in the blind spot area, giving undistorted representation of position as would a flat, planar mirror; and
Wide-angle view of the vertical, revealing the presence of objects below and above the normal filed of view of a flat, planar mirror.

When the blind spot curved mirror is properly positioned by the driver, and used in conjunction with conventional, available rearview mirrors, the driver may incur significantly less risk in assessing the presence of objects in the blind spot area. Head movement may be minimized, as the driver need only glance to the mirror to get a true assessment of position and width of whatever may be in the blind spot area. The driver further gets a relative assessment of height, and true indication of the presence of objects above and below the traditional field of view of the conventional mirrors. Thus, the driver may give more attention to the forward view.

In a preferred embodiment of the invention, the invention is affixed to one or more existing, external original equipment rear view mirrors on a motor vehicle. Such motor vehicles include automobiles, trucks, motorcycles, watercraft, and other powered vehicles.

In another preferred embodiment of the invention, the invention is integrated with a conventional external rear view mirror, wherein the entire assembly is manufactured and configured as original equipment mirrors for a motor vehicle.

In another preferred embodiment of the invention, the invention is affixed to existing original equipment mirror or integrated with a conventional rear view mirror for bicycle or other vehicle that is not powered by a motor.

### BRIEF DESCRIPTION OF THE DRAWINGS

FIG. 1 is a front view of a blind spot curved mirror assembly showing a curved mirror surface. FIG. 1 also shows the viewing planes of FIGS. 2 and 3.

FIG. 2 is a top view of the blind spot curved mirror, showing an outer shell. Also shown in FIG. 2 is the view plane for FIG. 6.

FIG. 3 is a side view of he blind spot curved mirror, showing internal mountings, adjusting means, and means or attaching to the outer shell. FIG. 3 also shows the view plane for FIG. 7.

FIG. 4 illustrates a bottom view of the blind spot curved mirror assembly.

FIG. 5 illustrates another embodiment, with a blind spot curved mirror and flat mirror combined in a single shell.

FIG. 6 illustrates a cross sectional view of a ball portion of the mirror support and universal.

FIG. 7 illustrates a cross sectional view of a socket on the rear, interior of the blind spot curved mirror.

FIG. 8 illustrates a side view of a blind spot curved mirror assembly mounted on a conventional truck mirror frame.

FIG. 9 illustrates a top view of the blind spot curved mirror truck mount assembly.

FIG. 9A illustrates a side view of the truck mount assembly.

### DETAILED DESCRIPTION

A complete understanding of the present invention may be obtained by reference to the accompanying drawings, when considered in conjunction with the subsequent, detailed description.

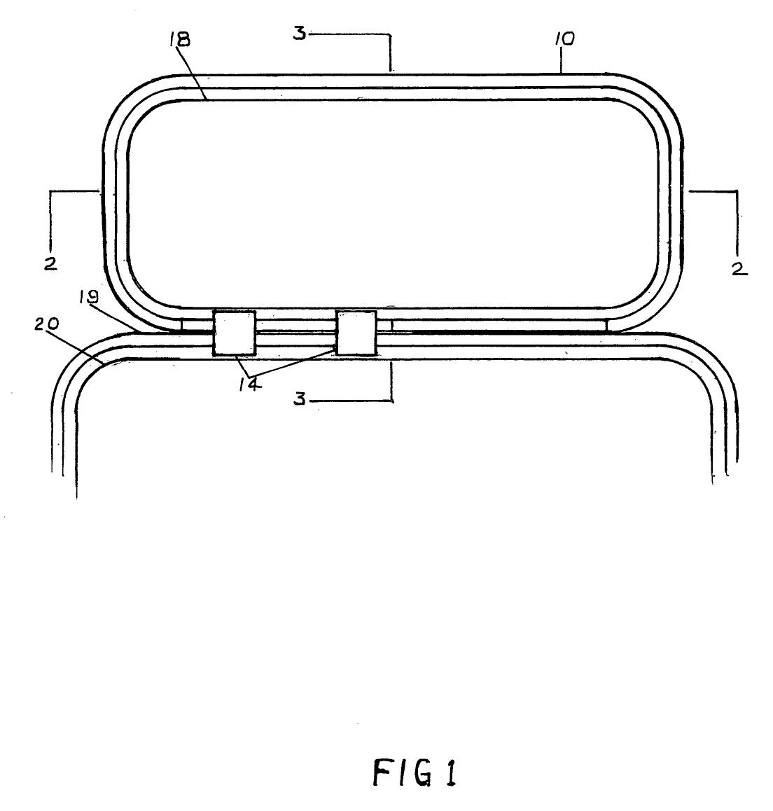

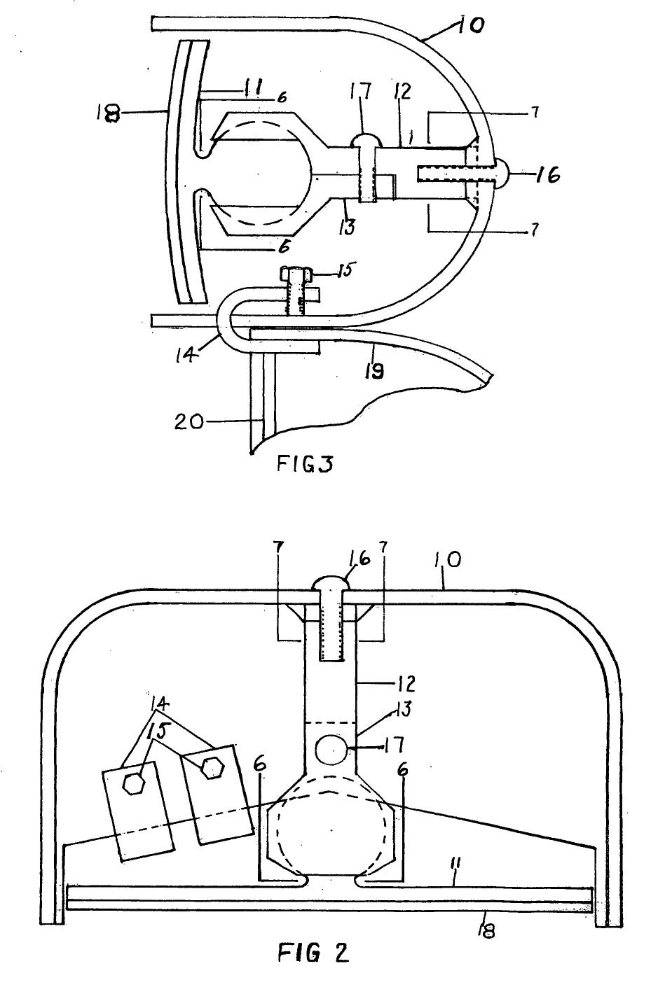

FIG. 1 is a front view of a blind spot curved mirror assembly showing a curved mirror reflector 18 mounted in a blind spot curved mirror outer shell 10. The blind spot curved mirror outer shell is secured to a vehicle original equipment mirror outer shell 19 by one or more blind spot curved mirror mount clamps 14. FIG. 1 also shows the viewing planes of FIGS. 2 and 3.

The curved mirror reflector 18 is curved from top to bottom in the profile plane, and is straight, or not curved, from side to side in the top plane. Thus, along any horizontal line of the blind spot curved mirror, the reflection is true and undistorted. This extends the image of the original equipment side mirror to which it is attached, to cover the blind spot area. Thereby, the driver's peripheral vision is augmented by a true horizontal representation of width size of objects in the blind spot area.

Furthermore, the top to bottom curve will present a wide angle by slightly shortened image of objects in the blind spot. This allows the driver to see objects low to the ground, such as curbs. The driver will also see objects that are higher above the ground, such as the bodies of high truck trailers.

FIG. 2 is a top view of the blind spot curved mirror outer shell 10, showing a floor side “V” angle 27 disposed at the bottom, with a vertex defined between the front plane and rear plane of the blind spot curved mirror outer shell 10, with the “V” angle 27 open towards the front plane of the blind spot curved mirror outer shell 10. As viewed form the top, the “V” angle 27 has a left segment and a right segment with respect to the vertex of the angle. Further, the top view of the original equipment mirror outer shell 19 shows a mounting edge that is on top of the original equipment mirror outer shell 19. The mounting edge is generally positioned to face the rear of the vehicle. The “V” angle 27 serves as an indicium to provide a rough mounting reference for aiming the blind spot curved mirror outer shell 10 into the general blind spot area, such that further refining and adjusting of the aim may be done by the driver. The blind spot area tends to be outward and away from the vehicle. The traditional field of view as presented by conventional rear view mirrors generally covers the area close to the vehicle sides. Alignment of the left segment edge of the “V” angle 27 with the mounting edge of the original equipment mirror outer shell 19 that is on the left side of the vehicle (driver facing forward) causes the blind spot curved mirror to be aimed roughly into the blind spot area on that side of the vehicle. Similarly, alignment of the right segment of the “V” angle 27 with the mounting edge on a right side the original equipment mirror outer shell 19 roughly aims the blind spot curved mirror into the right side blind spot. The driver makes further, refined adjustments so that the blind spot curved mirror reflector 18 is aimed as desired. The blind spot curved mirror reflector 18 is secured to mirror support and a universal ball 11 with an appropriate adhesive or other fastening means. Mirror support and universal ball 11 is mounted in a universal ball socket 12 and secured by a tension adjuster 13 using tension adjuster screw 17. The tension adjuster 13 secures the mirror support and universal ball 11 to the universal ball socket 12, allowing the mirror support and universal ball 11 to pivot up, down, left, and right, thereby allowing the driver to make fine adjustments to aim into the blind spot area. Tension adjuster 13 and universal screw 17 are threaded to match. The tension adjuster screw 17 is adjusted to draw the tension adjuster 13 to the universal ball socket 12, thereby holding the mirror support and universal ball 11 pivotally into place. The universal ball socket 12 is adapted at its rear plane to receive a screw, thereby allowing the universal ball socket 12 to be attached to the outer shell 10. An assembly comprising the curved mirror reflector 18, as attached to the mirror support and universal ball 11, as mounted into the universal ball socket 12 and tension adjuster 13, is secured to blind spot curved mirror outer shell 10 by placing the assembly into a cavity formed by the outer shell 10, and fastening the assembly into position using a mirror assembly screw 16.

Each blind spot curved mirror mount clamp 14 is mounted onto the blind spot curved mirror outer shell 10 by a blind spot curved mirror mount clamp screw 15 as mounted on original equipment mirror outer shell 19. Each blind spot curved mirror mount clamp 14 binds the blind spot curved mirror outer shell 10 to the original equipment mirror outer shell 19, and the blind spot curved mirror mount clamp screw 15 secures the binding.

The blind spot curved mirror is affixed to the mirror support and universal arm 4 using an appropriate cement, adhesive, or other bonding means. The mirror support and universal arm 4 is attached to the universal using a universal fastener 13. The universal is attached to a mirror and universal mount 5 using a universal fastener 13. The mirror and universal mount 5 is attached to a blind spot curved mirror outer shell 10 using a mirror mount screw 16. The blind spot curved mirror outer 10 shell is attached to the vehicle original equipment mirror shell 19 by application of mirror assembly mount clamps 14 mirror assembly mount screws 15. Each such mount screw 15 passes through a threaded hole in one surface of each such mount clamp 14, and is adjusted to supply tension sufficient to hold the blind spot curved mirror outer shell 10 and the original equipment outer shell 19 together. The blind spot curved mirror will remain in the position set by the vehicle driver by friction strips 9.

Mounting on an existing mirror is accomplished with at least one mounting clamp 14 and one mounting screw 15.

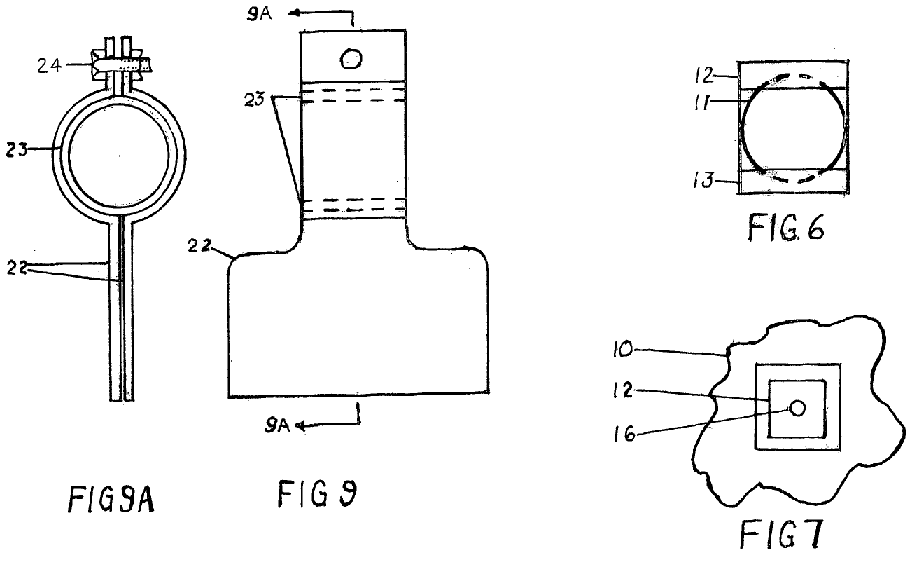

Also shown in FIG. 2 is the view plane for FIG. 6.

FIG. 3 is a side view of a curved mirror reflector 18 as affixed to the mirror support and universal ball 11. Mirror support and universal ball 11 is further shown as mounted within mirror support and universal ball socket 12, and secured by tension adjuster 13 and universal screw 17.

FIG. 3 shows the assembly comprising the curved mirror reflector 18, as attached to the mirror support and universal ball 11, as mounted into the universal ball socket 12 and tension adjuster 13, is secured to blind spot curved mirror outer shell 10 by placing the assembly into a cavity formed by the outer shell 10, and fastening the assembly into position using a mirror assembly screw 16.

FIG. 3 further shows the blind spot curved mirror outer shell 10 as mounted onto the original equipment mirror outer shell 19, by means of the blind spot curved mirror clamps 14 and the blind spot curved mirror clamp screws 15.

FIG. 3 also shows the view plane for FIGS. 7.

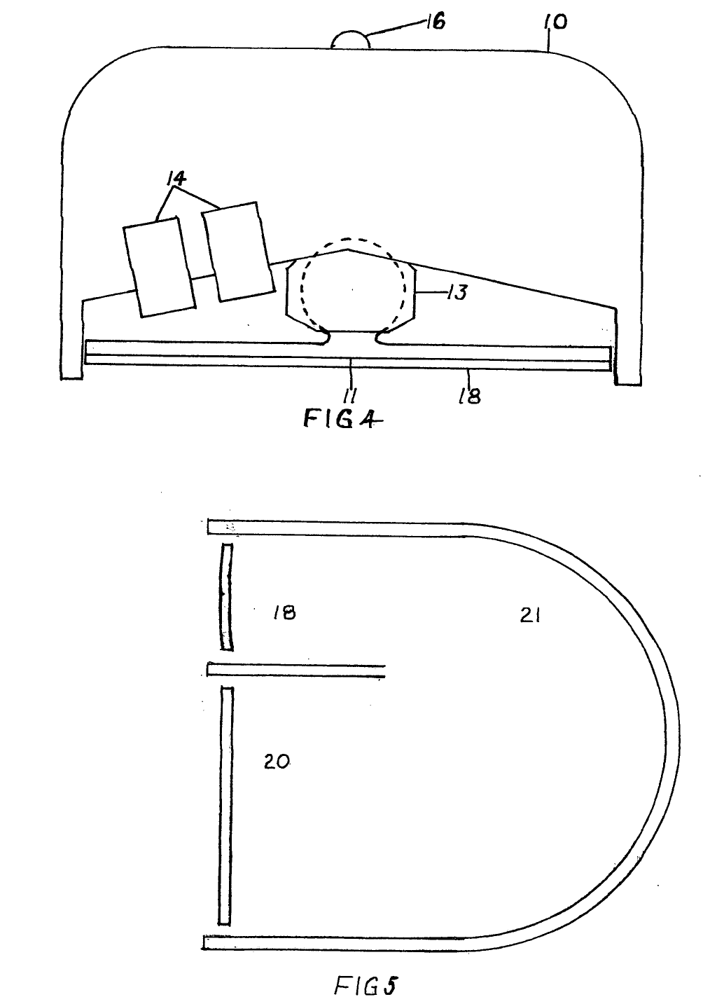

FIG. 4 is a bottom view of the blind spot curved mirror outer shell 10, showing the lower portion of tension adjuster 13, the lower edge of mirror support and universal ball 11, the lower edge of curved mirror 18, and the blind spot curved mirror mount clamps 14. This view further shows the “V” angle 27 in the blind spot curved mirror outer shell 10.

FIG. 5 is another embodiment, with a blind spot curved mirror and flat mirror combined in a single shell 21. The view is one representation showing how the blind spot curved mirror and conventional original equipment mirror may be combined as manufactured in a single outer shell. This view also contemplates the use of original equipment mirrors of any type, whether flat, spherical convex, or other shape.

FIG. 6 is a cross sectional view of a ball portion of the mirror support and universal ball 11, as secured in the mirror and universal ball socket 12 with tension adjuster 13 using universal screw 17 (not shown in FIG. 6).

FIG. 7 is a cross sectional view of a socket 26 on the rear, interior of the blind spot curved mirror outer shell 10, for receiving the assembly comprising the mirror support and universal ball 11, mirror support and universal ball socket 12, and tension adjuster 13 assembly, into blind spot curved mirror outer shell 10. The mount screw 16 and the rear portion of the mirror support and universal ball 12 are threaded to match. The mount screw 16 passes through a hole on the blind spot curved mirror outer shell 10, through the socked 26, and into the rear portion of the mirror support and universal ball 12.

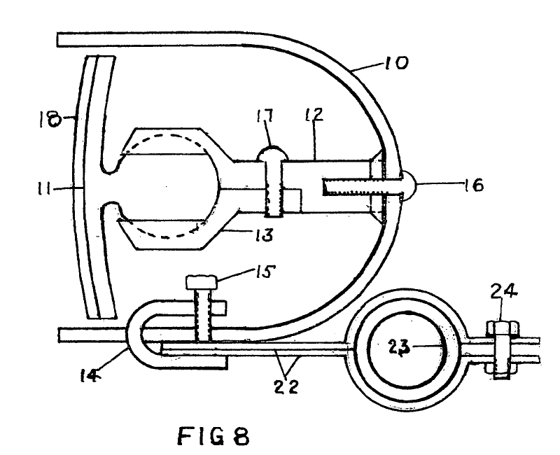

FIG. 8 is a side view of a blind spot curved mirror assembly mounted on a conventional truck mirror frame 23, using a truck mount 22 and truck mount bolt and nut 24. The truck mirror frame is generally rectangular, mounted vertically on the side of a truck, and is formed from tubular shaped materials.

FIG. 9 is a top view of the blind spot curved mirror truck mount assembly 25. The blind spot curved mirror truck mount assembly is made of two interchangeable parts 22, with each part having a platform end onto which the blind spot curved mirror assembly is attached, and a frame end which attaches to the top segment outer shell the conventional truck mirror frame 23. The two interchangeable parts 22 are combined to fit around the conventional truck mirror frame 23, and to provide a platform for mounting the blind spot curved mirror assembly. The platform end is expanded for mounting with one or more mirror mount clamps 14 and the blind spot curved mirror outer shell 10. The frame end is curved to define a cylinder, or is otherwise shaped, to fit around the truck mirror frame 23.

FIG. 9A is a side view of the truck mount assembly 25 and the interchangeable parts 22. The interchangeable parts 22 are secured at the frame end, surrounding the original equipment mirror fra me 23, by means of the truck mount bolt and nut 24.

For purposes of clarity and brevity, like elements and components will bear the same designations and numbering throughout the Figures.

Those of ordinary skill in the art will recognize that the blind spot curved mirror is easily adaptable to cooperate with a remote or power positioning means.

The blind spot curved mirror reflecting surface is adjusted by the observer with respect to the position and fields of view of existing original equipment rear view mirrors. The reflecting surface in a horizontal plane will extend the image area from the rear of a vehicle to the driver's peripheral vision.

Other modifications and changes, that may be required to fit particular operating requirements and environments, will be apparent to those skilled in the art. Thus, the invention is not considered limited to the example chosen for purposes of disclosure, and covers all changes and modifications that do not constitute departures from the true spirit and scope of this invention.

It is obvious from the foregoing that the facility, economy and efficiency of the blind spot curved mirror apparatus is improved by the cylindrical section mirror surface presenting to the observer a true width horizontal image size, and a true horizontal position of any objects in the blind spot area.

While the foregoing detailed description has described several embodiments of the blind spot curved mirror in accordance with principles of the invention, it is to be understood that the above description is illustrative only and is not limiting of the disclosed invention. Particularly other configurations of the blind spot curved mirror may include other single or double curved surfaces, including oblique cylinder, conical convolutes, and other single or double curved surfaces. Thus, the invention is to be limited only by the claims set forth below.

Having thus described the invention, what is desired to be protected by Letters Patent is presented in the subsequently appended claims.

1. Mirror apparatus enabling an observer to view objects in a rearward adjacent blind spot area wherein the apparatus comprises:
Reflecting means for reflecting to the observer a view of objects in the blind spot area, comprising a reflective surface in a frontal plane, wherein said reflective surface has a reflective side and a mounting side, and wherein said reflecting means reflects the view so as to show
a true reflection of horizontal width size of the objects,
a true reflection of horizontal position of the objects,
and a wide angle vertical reflection of the objects;
Mounting means for mounting and supporting said reflecting means, wherein said mounting means has a first end onto which said reflecting means is affixed, and a second end;
Positioning means for positioning said mounting means and said affixed reflecting means, wherein said positioning means pivotably attaches to said second end of said mounting, allowing the observer to aim the reflecting means into the blind spot area;
Said attached positioning means, said mounting means, and said reflecting means further comprising an internal assembly;
Housing means for covering said internal assembly, wherein said housing means
is attached to said internal assembly,
provides protection from exposure to weather,
and provides acceptable aerodynamic air flow around said housing means;
Said housing means further comprising a mounting side at which said housing means is attachable to an external structure; and;
Attachment means affixed to said housing means, wherein said attachment means joins said housing means to a vehicle such that the driver may see said mirror apparatus.

2. A mirror apparatus of claim 1 wherein said reflecting side comprises a curved surface configured as a single curve convex section, said reflective surface being singly curved in each profile plane cross section, and not curved in any horizontal plane cross section.

3. A mirror apparatus of claim 1 wherein said second end of said mounting means comprises a ball configured to cooperate with a socket.

4. A mirror apparatus of claim 3 wherein said positioning means comprises a socket for receiving and for cooperating with said ball, for PivotTable adjustment of said mounting means.

5. A mirror apparatus of claim 1 wherein said attachment means attaches said mirror apparatus to a vehicle at an effective angle in the horizontal plane, thereby being roughly and statically aimed into the blind spot area.

6. A mirror apparatus of claim 1 wherein said attachment means attaches said mirror apparatus to an existing external rearview mirror at an effective angle in the horizontal plane, thereby being roughly and statically aimed into the blind spot area for reflecting images therein to the observer.

7. A mirror apparatus of claim 6 further comprising an alignment indicium means on said mounting side of said housing means wherein said alignment indicium means indicates the placement of the mirror apparatus and the external rearview mirror apparatus thereby causing formation of said effective angle in relation to the observer.

8. A mirror apparatus of claim 1 wherein said mirror apparatus is integrated with at least one additional mirror forming an integrated apparatus, said integrated apparatus being mounted into and covered by a common housing means for protection from exposure to weather, and said common housing means further providing acceptable aerodynamic air flow around said common housing means.

9. A mirror apparatus of claim 1 wherein the external structure is a mirror apparatus.

10. A mirror apparatus of claim 1 wherein the external structure is a vehicle.

11. Mirror apparatus attached to an original equipment mirror outer shell enabling an observer to view objects in a rearward adjacent blind spot area wherein the apparatus comprises:
a curved mirror reflector, for revealing objects in the blind spot to the observer;
a mirror support with a universal ball affixed at one end, for supporting and focusing said curved mirror reflector;
a universal ball socket, for supporting said mirror support and affixed universal ball, and said affixed curved mirror reflector;
a tension adjuster, for securing said mirror support and said universal ball to said universal ball socket, and for providing sufficient tension on said affixed universal ball to hold said mirror support and said affixed universal ball in place as set by the observer;
a tension adjusting screw, for securing said mirror support and said affixed universal ball to said universal ball socket, and for providing adjustable tension on said affixed universal ball;
said curved mirror reflector, said mirror support and universal ball, said universal ball socket, said tension adjuster, and said tension adjusting screw further comprising an internal assembly;
an outer shell, for housing and supporting said internal assembly;
at least one assembly screw, for attaching said curved internal assembly to said outer shell;
at least one mount clamp, for securing said outer shell to the original equipment mirror outer shell;
at least one mount clamp screw applied to said mount clamp and to the original equipment outer shell, for rendering immobile said outer shell with respect to the original equipment outer shell.

12. Mirror apparatus enabling an observer to view objects in a rearward adjacent blind spot area and into an area not in the blind spot area, wherein the apparatus comprises:
a curved mirror reflector, for revealing objects in the blind spot to the observer;
a mirror support with a universal ball affixed at one end and said curved mirror reflector affixed on another end, for supporting and focusing said curved mirror reflector into a desired viewing area;
at least one additional mirror focused by the observer to provide a view into an area not viewed by said curved mirror reflector;
a universal ball socket, for supporting said mirror support and said affixed universal ball, and said affixed curved mirror reflector;
a tension adjuster, for securing said affixed universal ball of said mirror support to said universal ball socket, and for providing sufficient tension on said affixed universal ball to hold said mirror support and said affixed universal ball in place as set by the observer;
a tension adjusting screw, for securing said mirror support and said affixed universal ball to said universal ball socket, and for providing adjustable tension on said affixed universal ball;
said curved mirror reflector, said mirror support and universal ball, said universal ball socket, said tension adjuster, and said tension adjusting screw further comprising an internal assembly; and
an outer shell, for housing and supporting said internal assembly and said at least one additional mirror, said outer shell being attached to a vehicle in position to reflect the rear view to the observer; and
at least one assembly screw, for attaching said internal assembly to said outer shell.
